(19) United States
(12) Patent Application Publication
(10) Pub. No.: US 2021/0058548 A1
(43) Pub. Date: Feb. 25, 2021

(54) CLOUD VISION MONITORING SYSTEM AND CLOUD VISION MONITORING DEVICE

(71) Applicant: MING-TSUNG CHEN, Taipei City (TW)

(72) Inventor: MING-TSUNG CHEN, Taipei City (TW)

(21) Appl. No.: 16/550,128

(22) Filed: Aug. 23, 2019

(51) Int. Cl. H04N 5/232; G06T 1/00; G06K 9/00; G06T 5/50; G06T 5/00

(52) U.S. Cl. CPC H04N 5/23218; G06T 1/0014; G06T 5/001; G06T 5/50; G06K 9/0063

(57) ABSTRACT

A cloud vision monitoring system and a cloud vision monitoring device are provided. The cloud vision monitoring system includes a server and a first cloud vision monitoring device. The first cloud vision monitoring device detects at least one feature of an object based on an image of the object. The first cloud vision monitoring device includes a camera, a multi-directional image capturing auxiliary module, and a serial control communication module. When the object is placed between a first side and a second side of the multi-directional image capturing auxiliary unit of the multi-directional image capturing auxiliary module, the camera module simultaneously captures a first image and a second image of the object, and the first image and the second image are images of two opposite sides of the object, respectively.

### FIELD OF THE DISCLOSURE

The present disclosure relates to a monitoring system and a monitoring device, and more particularly to a cloud vision monitoring system and a cloud vision monitoring device.

### BACKGROUND OF THE DISCLOSURE

At present, although the IoT technology is introduced in the agricultural or fishery industry for monitoring production, it is rarely used for any other purpose. The actual growth process of agricultural and fishery products cannot be regularly grasped. When it is necessary to regularly monitor the growth process of agricultural and fishery products, a lot of manpower and material resources will be required, and the growth process of agricultural and fishery products will be affected.

Therefore, it is an important subject to provide a cloud vision monitoring system and a cloud vision monitoring device in the industry.

### SUMMARY OF THE DISCLOSURE

In response to the above-referenced technical inadequacies, the present disclosure provides a cloud vision monitoring system. The cloud vision monitoring system includes a server and a first cloud vision monitoring device. The first cloud vision monitoring device detects at least one feature of an object based on an image of the object. The first cloud vision monitoring device includes a camera module, a multi-directional image capturing auxiliary module, and a serial control communication module. The multi-directional image capturing auxiliary module includes a multi-directional image capturing auxiliary unit. The multi-directional image capturing auxiliary unit includes a first side and a second side. The camera module is defined at the first side of the multi-directional image capturing auxiliary unit. The second side of the multi-directional image capturing auxiliary unit is a surface with a predetermined curvature. The object is placed between the first side and the second side. The serial control communication module is electrically connected to the camera module. When the object is placed between the first side and the second side of the multi-directional image capturing auxiliary unit, the camera module simultaneously captures a first image and a second image of the object. The first image and the second image are images of two opposite sides of the object, respectively.

In one aspect, the present disclosure provides a cloud vision monitoring device. The first cloud vision monitoring device includes a camera module, a multi-directional image capturing auxiliary module, and a serial control communication module. The multi-directional image capturing auxiliary module includes a multi-directional image capturing auxiliary unit. The multi-directional image capturing auxiliary unit includes a first side and a second side. The camera module is defined at the first side of the multi-directional image capturing auxiliary unit. The second side of the multi-directional image capturing auxiliary unit is a surface with a predetermined curvature. The object is placed between the first side and the second side. The serial control communication module is electrically connected to the camera module. When the object is placed between the first side and the second side of the multi-directional image capturing auxiliary unit, the camera module simultaneously captures a first image and a second image of the object. The first image and the second image are images of two opposite sides of the object, respectively.

Therefore, the cloud vision monitoring system and the cloud vision monitoring device can regularly record the growth states of the object, and the camera module can capture the images of the two opposite sides of the object, respectively. Furthermore, the image-capturing action will not affect the growth process of the object, the cost of the equipment can be reduced, and the measurement efficiency can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a block diagram of a cloud vision monitoring system of a first embodiment of the present disclosure.

FIG. 2 is a block diagram of the cloud vision monitoring system in FIG. 1.

FIG. 3 is a perspective view of a multi-directional image capturing auxiliary module supporting an object.

FIG. 4 is a perspective view of the multi-directional image capturing auxiliary module supporting the object.

FIG. 5 is a perspective view of a first image and a second image of the cloud vision monitoring system of the first embodiment of the present disclosure.

FIG. 6 is a perspective view of a cloud vision monitoring system of a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

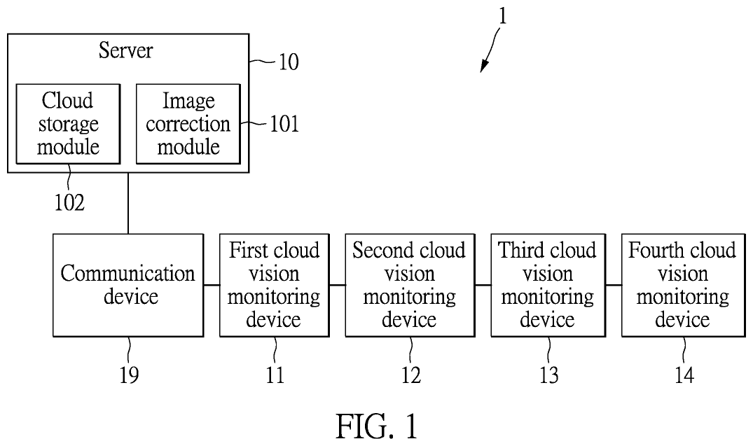

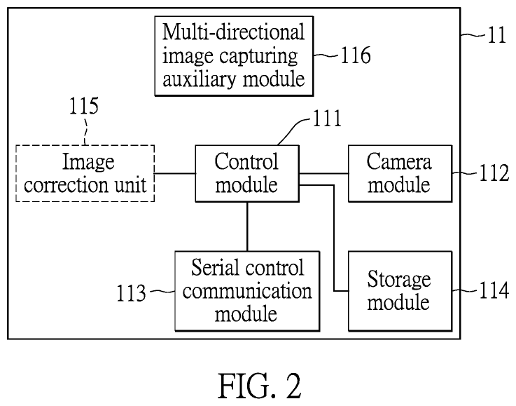

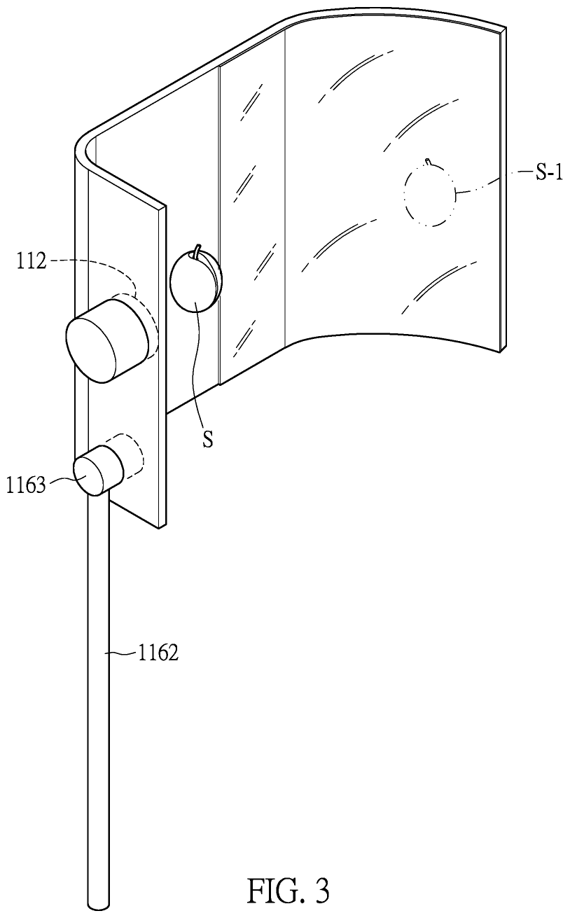

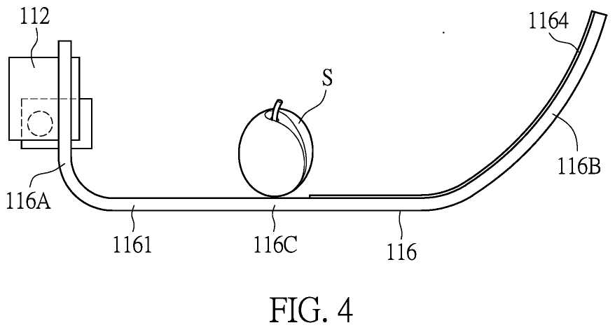

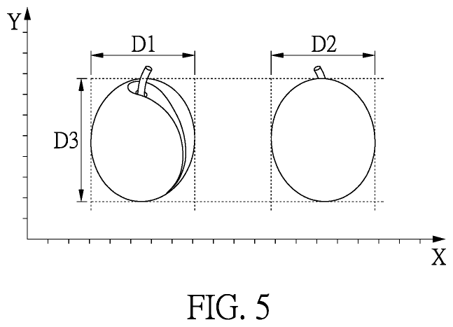

Referring to FIG. 1, FIG. 2, FIG. 3, FIG. 4, and FIG. 5, FIG. 1 is a block diagram of a cloud vision monitoring system of a first embodiment of the present disclosure. FIG. 2 is a block diagram of the cloud vision monitoring system in FIG. 1. FIG. 3 is a perspective view of a multi-directional image capturing auxiliary module supporting an object. FIG. 4 is a perspective view of the multi-directional image capturing auxiliary module supporting the object. FIG. 5 is a perspective view of a first image and a second image of the cloud vision monitoring system of the first embodiment of the present disclosure.

A cloud vision monitoring system 1 includes a server 10, a first cloud vision monitoring device 11, a second cloud vision monitoring device 12, a third cloud vision monitoring device 13, a fourth cloud vision monitoring device 14, and a communication device 19. The first cloud vision monitoring device 11 communicates with the second cloud vision monitoring device 12 in a wired manner. The second cloud vision monitoring device 12 communicates with the third cloud vision monitoring device 13 in a wired manner. The third cloud vision monitoring device 13 communicates with the fourth cloud vision monitoring device 14 in a wired manner. The first cloud monitoring device 11 communicates with the communication device 19. The communication device 19 communicates with the server 10 in a wired manner or in a wireless manner. In other words, the data of the cloud monitoring devices 11-14 can be transmitted to the server through the communication device 19. In the embodiment, a number of the cloud monitoring devices is adjusted based on the actual requirement, and is not limited in the present disclosure.

Each of the cloud vision monitoring devices 11-14 detects at least one feature of the object S based on an image of the object S. The feature of the object S includes: length, color, appearance, but is not limited in the present disclosure.

Since the cloud visual monitoring devices 11-14 all have the same structure and function, the first cloud visual monitoring device 11 is taken as an example for description, and descriptions of other cloud vision monitoring devices are omitted.

The first cloud vision monitoring device 11 includes a control module 111, a camera module 112, a serial control communication module 113, a storage module 114 and a multi-directional image capturing auxiliary module 116. The control module 111, the camera module 112, the serial control communication module 113, and the storage module 114 are mounted on the multi-directional image capturing auxiliary module 116. The multi-directional image capturing auxiliary module 116 includes a multi-directional image capturing auxiliary unit 1161, a support rod 1162 and a rotating shaft 1163. The control module 111 is electrically connected to the camera module 112, the serial control communication module 113, and the storage module 114. The serial control communication module 113 is electrically connected to the camera module 112. In the embodiment, the multi-directional image capturing auxiliary unit 1161 is a U-shaped support plate for supporting the object S. The multi-directional image capturing auxiliary unit 1161 is mounted on the support rod 1162 through the rotating shaft 1163. A support angle of the multi-directional image capturing auxiliary unit 1161 can be adjusted by the rotating shaft. Therefore, the camera module 112 can capture the image data of the object S. In the embodiment, the object S is a fruit, such as a strawberry, a guava, a grapefruit, a mango or a blueberry, and is not limited in the present disclosure. A size of the multi-directional image capturing auxiliary unit 1161 is determined based on the actual requirement, and is not limited in the present disclosure.

The multi-directional image capturing auxiliary unit 1161 includes a first side 116A, a second side 116B, and a bottom plate 111C. The bottom plate 116C is defined between the first side 116A and the second side 116B. An angle is defined between the first side 116A and the bottom plate 116C of the multi-directional image capturing auxiliary unit 1161. In the embodiment, the angle between the first side 116A and the bottom plate 116C is a right angle. In other embodiment, the angle between the first side 116A and the bottom plate 116C can be larger than or less than 90 degrees. The second side 116B is a curved surface with a predetermined curvature.

The object S is arranged between the first side 116A and the second side 116B. In other words, the object S is arranged on the bottom plate 116C. In addition, a reflective coating 1164 is coated on the second side 116B of the multi-directional image capturing auxiliary unit 1161. The object S is not required to be picked from the plant.

When the object S is arranged between the first side 116A and the second side 116B of the multi-directional image capturing auxiliary unit 1161, the camera module 112 simultaneously captures a first image and a second image of the object S. The first image and the second image are two images of the two opposite sides of the object S. In other words, the camera module 112 captures the first image of the object S that is adjacent to the first side 116A of the multi-directional image capturing auxiliary unit 1161. The camera module 112 also captures the second image of the opposite sides of the object S from the image S−1 on the reflective coating 1164 of the second side 116B of the multi-directional image capturing auxiliary unit 1161. In other words, the camera module 112 simultaneously captures the two images of the opposite sides of the object S through the multi-directional image capturing auxiliary unit 1161. In the embodiment, the first image and the second image of the object S are stored in the storage module 114. Then, the control module 111 transmits the first image and the second image to the server 10 through the serial control communication module 113.

In the embodiment, the control module 111 of the cloud vision monitoring device 11 can regularly turn on the camera module 112 to capture the images of the object S. It is not necessary to repeatedly adjust the position of the object, and the growth of the plant will not be affected.

Since the second side 116B of the multi-directional image capturing auxiliary unit 1161 is a surface with a predetermined curvature, the second image of the object S is a distorted image. In the embodiment, the server 10 will correct the distortion of the second image based on the predetermined curvature of the second side 116B of the multi-directional image capturing auxiliary unit 1161 to generate a corrected second image. In addition, the server stores the first image and the corrected second image in a cloud storage module 101 of the server 10. In other words, the server 10 includes an image correction module 102 to execute the correction of the second image. In other embodiments, each of the cloud vision monitoring devices 11-14 can optionally include an image correction unit 115 to correct the second image, but is not limited in the present disclosure.

In the embodiment, the serial control communication module 113 is an RS485 serial control module or an RS232 serial control module, which is not limited in the present disclosure. In other words, the serial control communication module 113 of the first cloud vision monitoring device 11 communicates with the serial control module (not shown) of the second cloud vision monitoring device 12. The serial control module (not shown) of the second cloud vision monitoring device 12 communicates with the serial control module (not shown) of the third cloud vision monitoring device 13. The serial control module (not shown) of the third cloud vision monitoring device 13 communicates with the serial control module (not shown) of the fourth cloud vision monitoring device 14.

As shown in FIG. 5, the control module 111 can add length coordinates in the images of the object S captured by the camera module 112, which marks the length values D1-D3 of object S. In other embodiment, the camera module 112 can include a measuring unit (not shown) defined at a front side of the camera module for measuring the length values D1-D3 of the objects

### Second Embodiment

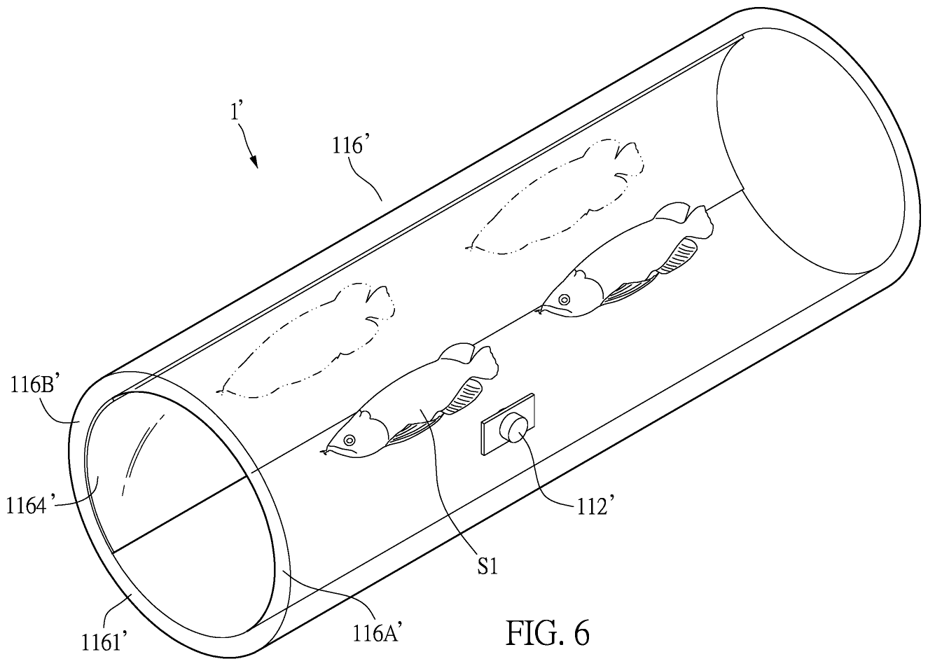

Referring to FIG. 6, FIG. 6 is a perspective view of a cloud vision monitoring system of a second embodiment of the present disclosure.

A cloud vision monitoring system 1′ is configured to be under water. A multi-directional image capturing auxiliary unit 1161′ of a multi-directional image capturing auxiliary module 116′ is a tube. The camera module 112′ is defined at a first side 116A′, and a second side 116B′ of the multi-directional image capturing auxiliary unit 1161′ has a reflective coating 1164′.

Since the cloud vision monitoring system 1′ is configured in the water, aquatic creatures, such as fish, shrimps, or crabs, can be led through the tube-shaped multi-directional image capturing auxiliary unit 1161′ by feeding food.

Similarly, the images of the object 51 can be transmitted to the server (not shown) through the serial control module (not shown) and the communication device (not shown) for image correction, image storage, and big data analysis.

In other embodiments, the shape of the multi-directional image capturing auxiliary unit 1161′ can be adjusted based on the actual requirement, and is not limited in the present disclosure.

In conclusion, the cloud vision monitoring system and the cloud vision monitoring device can regularly record the growth states of the object, and the camera module can capture the images of the two opposite sides of the object. Furthermore, the image-capturing action will not affect the growth process of the object, the cost of the equipment can be reduced, and the measurement efficiency can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A cloud vision monitoring system, comprising:
a server; and
a first cloud vision monitoring device, communicating with the server, the first cloud vision monitoring device detecting at least one feature of an object based on an image of the object, the first cloud vision monitoring device including:
a camera module;
a multi-directional image capturing auxiliary module including a multi-directional image capturing auxiliary unit, the multi-directional image capturing auxiliary unit including a first side, a bottom plate and a second side, the first side being perpendicularly connected to a side of the bottom plate, the second side being disposed at another side of the bottom plate, the first side and the second side being opposite sides, the camera module being disposed at the first side of the multi-directional image capturing auxiliary unit, the second side of the multi-directional image capturing auxiliary unit being a surface with a predetermined curvature, and the object being arranged between the first side and the second side; and a serial control communication module electrically connected to the camera module, the object being arranged on the bottom plate;
wherein when the object is arranged between the first side and the second side of the multi-directional image capturing auxiliary unit, the camera module simultaneously captures a first image and a second image of the object, and the first image and the second image are images of two opposite sides of the object, respectively.

2. The cloud vision monitoring system of claim 1, wherein the server includes a cloud storage module, the first image and the second image are transmitted to the server, the server executes an image correction process for the second image to generate a corrected second image, and the first image and the corrected second image are stored in the cloud storage module.

3. The cloud vision monitoring system of claim 1, further comprising a second cloud vision monitoring device, wherein the second cloud vision monitoring device includes a serial control communication module, and the serial control communication module of the first cloud vision monitoring device communicates with the second cloud vision monitoring device.

4. The cloud vision monitoring system of claim 1, wherein the first cloud vision monitoring device further includes a control module and a storage module, and the control module is electrically connected to the storage module, the camera module, and the serial control communication module.

5. The cloud vision monitoring system of claim 1, wherein the second side of the multi-directional image capturing auxiliary unit includes a reflective coating, and the second image is captured from an image of the object on the reflective coating.

6. The cloud vision monitoring system of claim 1, wherein the serial control communication module is coupled with a communication device, the first cloud vision monitoring device transmits the first image and the second image of the object to the server through the communication device and the serial control communication module of the first cloud vision monitoring device.

7. The cloud vision monitoring system of claim 1, wherein the serial control communication module is an RS485 serial control module or an RS232 serial control module.

8. A cloud vision monitoring device, comprising:
a camera module;
a multi-directional image capturing auxiliary module, including a multi-directional image capturing auxiliary unit, the multi-directional image capturing auxiliary unit including a first side, a bottom plate and a second side, the camera module being disposed at the first side of the multi-directional image capturing auxiliary unit, the second side of the multi-directional image capturing auxiliary unit being a surface with a predetermined curvature, and the object being arranged on the bottom plate between the first side and the second side, the first side being connected to the second side through the bottom plate, the first side being perpendicularly connected to a side of the bottom plate, the and the second side being disposed at another side of the bottom plate, the first side and the second side being opposite sides; and
a serial control communication module electrically connected to the camera module;
wherein when the object is arranged between the first side and the second side of the multi-directional image capturing auxiliary unit, the camera module simultaneously captures a first image and a second image of the object, and the first image and the second image are images of two opposite sides of the object, respectively.

9. A cloud vision monitoring device, comprising:
a camera module;
a multi-directional image capturing auxiliary module, including a multi-directional image capturing auxiliary unit, the multi-directional image capturing auxiliary unit including a first side, a bottom plate and a second side, the camera module being disposed at the first side of the multi-directional image capturing auxiliary unit, the second side of the multi-directional image capturing auxiliary unit being a surface with a predetermined curvature, and the object being arranged between the first side and the second side, the first side being connected to the second side through the bottom plate, the first side being perpendicularly connected to a side of the bottom plate, the and the second side being disposed at another side of the bottom plate, the first side and the second side being opposite sides; and
a serial control communication module electrically connected to the camera module;
wherein when the object is arranged between the first side and the second side of the multi-directional image capturing auxiliary unit, the camera module simultaneously captures a first image and a second image of the object, and the first image and the second image are images of two opposite sides of the object, respectively;
wherein the server includes a cloud storage module, the first image and the second image are transmitted to the server, the server executes an image correction process for the second image to generate a corrected second image, and the first image and the corrected second image are stored in the cloud storage module, the first image is not corrected by the server.
